(19) United States
(12) Patent Application Publication
(10) Pub. No.: US 2022/0170189 A1
(43) Pub. Date: Jun. 2, 2022

(54) A DEVICE AND A METHOD FOR REAL-TIME IDENTIFICATION OF DEFECTS IN FABRICS, DURING WEAVING

(71) Applicant: SANTEX RIMAR GROUP S.R.L., Trissino, VICENZA (IT)

(72) Inventors: Giulio MANDRUZZATO, VICENZA (IT); Simone RANCAN, VICENZA (IT)

(21) Appl. No.: 17/425,811

(22) PCT Filed: Apr. 15, 2020
(86) PCT No.: PCT/IB2020/053541

§ 371 Date: Jul. 26, 2021

(30) Foreign Application Priority Data
Apr. 16, 2019 (IT) 102019000005826

(51) Int. Cl. D03J 1/00; D06H 3/08; G01N 21/898

(52) U.S. Cl. CPC D03J 1/007; G01N 21/8983; D06H 3/08

(57) ABSTRACT

A defect identification device for identifying defects in fabrics comprising a support frame fitted with a crossbar supporting at least one video camera for capturing images of a fabric while it is being woven, movement means for moving the at least one video camera, a processing and control unit programmed to control the movement means to move the video camera automatically in real time along a transverse weft direction (X-X), acquiring in advance the geometry of the fabric to be made and setting at least one theoretical dimensional parameter of comparison and a tolerance limit value for said theoretical dimensional parameter, capturing images of the fabric being formed in real time, processing said images so as to acquire said actual dimensional parameter of the fabric being formed and compare it to the theoretical dimensional parameter, detecting the presence of a weaving error.

### FIELD OF APPLICATION

The present invention refers to a device and method for the real-time detection of defects in fabrics.

Real-time detection means that the detection takes place during weaving, not afterward.

### PRIOR ART

The quality control process for identifying defects in fabrics is normally done downstream of the fabric production process.

The fabric is produced on machines called looms which, by weaving the weft and warp according to predetermined patterns set by the operator based on the design of the fabric, produce the fabric and store it by wrapping it onto a warp beam that is removed at the end of the operation once the desired quantity has been produced.

During the normally unattended production phase, the machine operates independently by following a program set on the control unit.

An operator can occasionally come by and check the production status.

Machine shutdowns occur in the event of serious problems during the process. During the fabric production phase, defects that may arise are not detected; only those which cause a machine shutdown are observed. There is no way to identify and categorize defects during production, nor indicate their location. After the fabric is produced, other preparation or finishing operations are often performed, and the resulting roll is sent to inspection machines for inspection where operators perform a 100% visual check of the condition of the fabric and indicate and mark defects.

The weaving operation is a process that is performed automatically by the looms, and has the following features:
it is a slow and costly operation requiring the use of special automated machines called looms,
there is no human attendance other than random checks during the weaving process,
given the slowness of the fabric production process, many machines positioned together in special rooms called weaving rooms, are used,
each weaving room may contain from a few units to several hundred looms, and each operator must work on many machines to ensure their efficiency and operability, taking action only when serious problems stopping production arise,
the quality control of fabric is not done on the loom, but in subsequent downstream operations with fabric inspection equipment.

For this reason, the cost of operations to check for and identify defects is currently high, since they are performed visually by an operator downstream of the production process, which does not allow defects to be corrected at the source.

Having a system that automatically performs quality control of the fabric directly on the loom would save a lot of time in the downstream process, would avoid having to do this operation with operators, and would provide a map of the fabric's defects making it possible to automate many of the downstream processes of fabric production. In addition, it would reduce the number of defects encountered by making it possible to correct them during production and keep them from being repeated.

Given the slow production typical of looms, the image acquisition operation as the fabric is being made is not particularly burdensome from a mechanical point of view. It is easy to build equipment that, with the help of electric motors, can keep pace with the fabric production rate and scan 100% of production.

However, the size of the yarns and their geometric composition complicate this activity, requiring the use of very sensitive optics and video cameras with very precise focal lengths and high resolution.

These properties are at odds with the particularities of a loom, including the presence of strong vibrations due to the movement of the comb which can disrupt the image acquisition process.

The video cameras must have the ability to quickly generate high-resolution images of limited fields at very tight intervals. In addition to having to keep pace with the fabric formation speed, the mechanical system must also be able to absorb the vibrations produced by the machine as best possible, vibrations which could adversely affect the quality of the captured images by making them blurry or illegible.

All the known mechanical systems use the same morphology, electric motors to move video cameras attached to crossbars that support and guide them. Image capture is done from the loom and the images are sent to processing units that analyze them.

These known systems may differ from each other in the number of video cameras used and the type of acquisition and the sensitivity of the optical sensor.

They generally have algorithms based on defect recognition implemented after adequate training. This means that the algorithm needs to be taught how to recognize defects in rather long image acquisition sessions and the images are then viewed by operators who categorize them and determine which ones are free of defects and which are not, along with a description thereof.

Once the database is created, the algorithm is capable of operating efficiently by comparing to previously known and categorized images.

The viewing systems for defect checking that are currently commercially available are rather costly and only work well if a generally long training phase is first completed to teach them the defects that need to be detected, and then very large and cumbersome databases that can be used by the algorithm to work are created.

### PRESENTATION OF THE INVENTION

Consequently, there is a need to overcome the drawbacks and limitations cited in reference to the prior art.

The need to overcome the drawbacks and limitations of the prior art solutions is met by a defect detection device according to claim 1 and by a defect detection method according to claim 11.

### DESCRIPTION OF THE DRAWINGS

Further features and benefits of the present invention will be understood more clearly from the following description of its preferred and non-limiting embodiments, in which:

FIG. 1 shows a partial perspective view of a device for identifying defects in fabrics according to one possible embodiment of the present invention;

FIGS. 2a, 2b, 2c, and 2d show partial views of a device for identifying defects in fabrics according to additional possible embodiments of the present invention;

FIGS. 3a and 3b show views of fabrics without defects and views of fabrics with defects of various types, respectively;

FIGS. 4-7 show additional views of possible defects that may be found by an identification device according to the present invention.

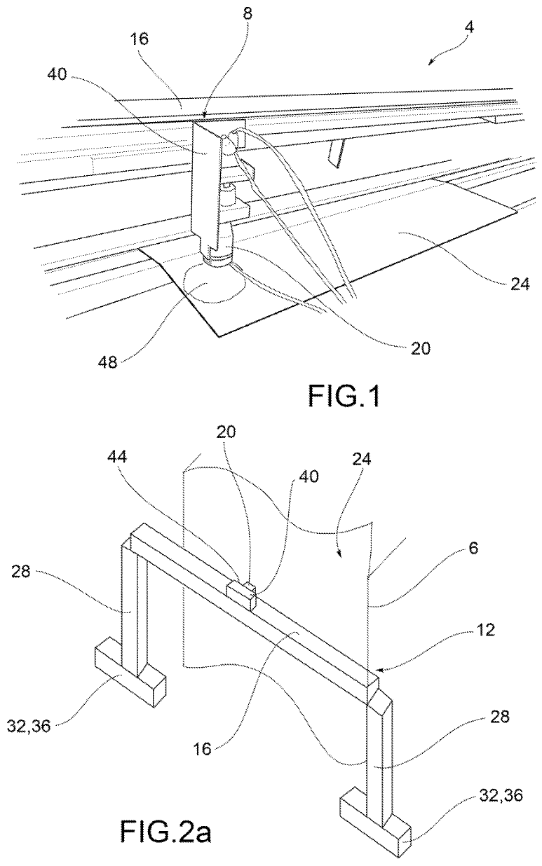

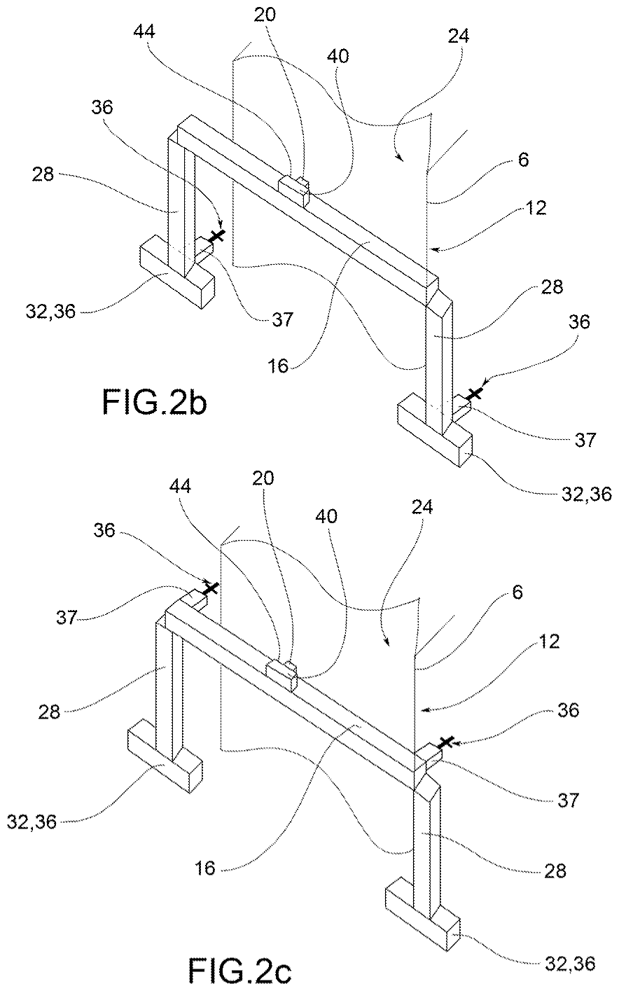

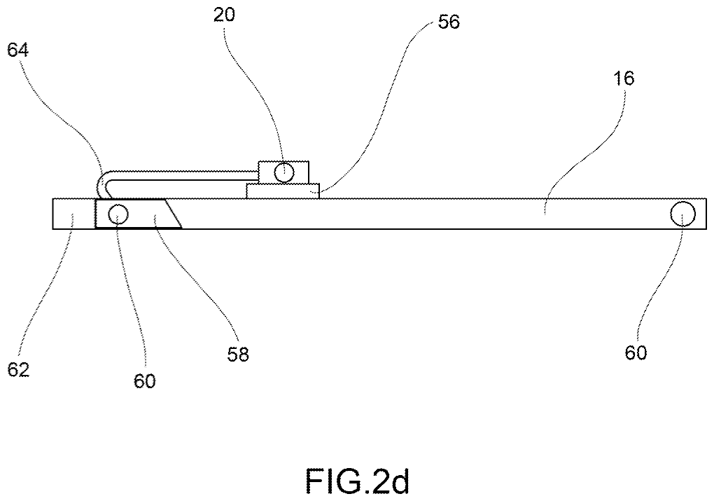

The elements or parts of elements that are in common between the embodiments described below will be indicated with the same number references.

### DETAILED DESCRIPTION

In reference to the aforementioned figures, the number 4 overall refers to a general view of a weaving machine or loom which is associated with a fabric defect identification device 8 according to the present invention.

In particular, weaving machine or loom 4 may be of any type and/or size for the purposes of this invention.

Fabric defect identification device 8 in turn comprises a support frame 12 fitted with a crossbar 16 supporting at least one video camera 20 for capturing images of a fabric 24 while it is being woven.

It must be noted that support frame 12 supporting defect identification device 8 may be independent or mechanically separate, or it may be associated with the frame of weaving machine 4.

Preferably, support frame 12 supporting defect identification device 8 is independent of the frame of weaving machine 4 so as to be isolated as much as possible from the vibrations generated during the weaving process. In this case, support frame 12 may also be provided with a pair of posts 28 equipped, for example, with damping means 36 to isolate it from the vibrations coming from the floor.

Alternatively, crossbar 16 may be associated directly with weaving machine 4, as shown.

In greater detail, according to one embodiment support frame 12, on which crossbar 16 supporting movement means 40 (typically carriage 56) is mounted, is independent and not mechanically connected to weaving machine 4 weaving fabric 24.

There are numerous reasons for decoupling support frame 12 supporting video camera 20 from weaving machine 4.

For example, the intension is to make the system versatile and easy to move from one weaving machine 4 to another. In other words, the same support frame 12 may be moved easily and used with different weaving machines 4, for instance in the same shop.

In addition, thanks to support frame 12 being mechanically independent of weaving machine 4, disturbances linked to intense vibrations and attachments due to the configuration of various types of weaving machine 4 can also be reduced.

Support frame 12 may rest on the floor or be secured to structural parts of weaving machine 4 and be positioned by means of special spacers 37 at the correct focal distance from fabric 24 so as to frame perfect images by means of video camera 20.

In addition, there are damping feet 36 attached to spacers 37 serving the purpose of attenuating and not transmitting vibrations to support frame 12 of video camera 20, so as not to disturb the image acquisition process and not to create distorted and/or illegible images.

For example, damping means 36 use feet made of an absorbent material capable of preventing the transmission of vibrations to support frame 12 supporting video camera 20. The entire structure of support frame 12 is positioned at the right distance set by the focal length of video camera 20 so that the system may work properly over the entire transverse width (that is, along weft direction X-X) of fabric 24.

Spacers 37 that set the distance by fabric 24 may obviously be adjusted to the requirements of video camera 20. Once the right distance is found, they are secured so that their position may not be changed.

Yet another embodiment includes a modified version of support frame 12 that may be placed on load-bearing parts of the frame of weaving machine 4 for weaving fabric 24.

This solution allows for a more compact installation. The position may be on load-bearing structures of the frame of weaving machine 4 for weaving fabric 24, to ensure the sturdiness of the support and positioning accuracy. The same type of spacers 37 and vibration damping means 36 described earlier to set the focal length and dampen the vibrations generated by weaving machine 4, which must not disturb the work of video camera 20 while images of fabric 24 are being acquired, are used.

Defect identification device 8 is provided with movement means 40 for moving at least one video camera 20 so as to frame the weaving process in real time.

In particular, the weaving process needs to be framed and monitored along the weft (direction X-X) and warp (direction Y-Y) of fabric 24 being formed (woven).

This means that movement means 40 must allow video camera 20 always to effectively frame the fabric being formed by following its movements along the weft and warp.

The movement means usually move along crossbar 16, which is parallel to the weft; As for the movement along the warp, perpendicular to the weft, fabric 24 is usually what moves thanks to the weaving machine, while the video camera does not move. It is also possible to use movement means that can move video camera 20 along the warp direction, at least partially, including with an angular tilting movement about an axis of rotation parallel to weft direction X-X.

Movement means 40 of video camera 20 may comprise various components. For example, they may include a carriage 56 sitting on crossbar 16 supporting it with guides that slide on each other. Belt 58 wrapped around two pulleys 60 in a closed circuit is hooked to carriage 56 and moves it crosswise on crossbar 16. Belt 58 is driven by a motor 62, typically an electric motor, placed on one side of crossbar 16 of carriage 56, which drives one of two lateral pulleys 60. Preferably, belt 58 is a toothed belt.

Video camera 20, which frames fabric 24, is mounted on carriage 56.

According to one embodiment, the power supply and the data and signal cable for video camera 20 are routed inside a flexible “cable chain” 64 that follows the movement of carriage 56.

In this way, fabric 24 may pass in front of video camera 20 in its production direction, i.e. warp direction Y-Y, whereas video camera 20 with its crosswise movement parallel to weft direction X-X will be capable of scanning the entire width of fabric 24 thanks to the movement of carriage 56 on which the video camera is mounted.

Advantageously, defect identification device 8 is provided with a programmed processing and control unit 44 to:
control movement means 40 to move video camera 20 in real time so as to follow the weaving process,
acquire in advance the geometry of fabric 24 to be made, and set at least one theoretical dimensional parameter of comparison and a tolerance limit value for said theoretical dimensional parameter,
capture images of fabric 24 being formed in real time,
process said images so as to acquire the actual dimensional parameter, corresponding to the theoretical dimensional parameter, obtained for fabric 24 being formed and compare it to the theoretical dimensional parameter,
detect the presence of a weaving error if the difference between the actual dimensional parameter and the theoretical dimensional parameter is greater than the tolerance value,
store the coordinates of corresponding fabric portions 48 having weaving errors.

It must be noted that processing and control unit 44 makes a comparison between the theoretical weaving to be performed, i.e. the specific weft and warp weave that is to be done on the loom, and the actual weaving, i.e. the actual result obtained, and determines the presence or absence of errors depending on whether or not the at least one predetermined dimensional parameter falls within the established tolerance value, that is, the maximum difference compared to its theoretical value.

The phrase “store the coordinates of corresponding fabric portions 48 having weaving errors” is understood to mean that the weft and warp values of said fabric portions 48 with errors are stored. Consequently, weaving proceeds as normal, but processing and control unit 44 stores all fabric portions 48 having defects.

It is also possible to have processing and control unit 44 be able to store the images of fabric portions 48 with weaving errors to create a corresponding database of errors made during weaving.

The theoretical dimensional parameter, to be monitored to identify the presence of weaving errors, may comprise the theoretical density of the weft T and/or warp O threads and/or the thickness of the weft T and/or warp O threads and/or the area S of holes H created by the crossing of two consecutive weft yarns T′,T′″ and two consecutive warp yarns O′,O′″ intersecting with each other.

Lastly, the theoretical dimensional parameter may also comprise a measurement of the sides of said holes H.

It must be pointed out that the above examples of theoretical dimensional parameters are not alternatives or exclusive of each other; in other words, it is possible to monitor just one of the above-listed dimensional parameters, but also two or more of them in any combination with each other.

Depending on the specific type of fabric and weave to be obtained, it is also possible to establish a hierarchy between the various types of theoretical dimensional parameters to be monitored, or it is also possible to vary the maximum permissible tolerances or differences in connection with such a hierarchy, i.e. in relation to the importance of each said dimensional parameter.

For example, a lower tolerance can be assigned as the significance of the dimensional parameter rises, and vice versa.

According to one possible embodiment, processing and control unit 44 is programmed to catalogue the type of defect based on the number and type of non-compliant theoretical dimensional parameters.

It is also possible to call for processing and control unit 44 to be programmed to catalogue the type of defect according to the amount of the difference and the differences.

For example, fabric defect identification device 8 may comprise at least one screen for displaying at least fabric portions 48 with errors or defects D.

According to one possible embodiment, processing and control unit 44 comprises the step of subdividing fabric 24 into areas with and without defects, which calls for the step of cataloging the areas with defects as a function of the number and/or defect.

It must be noted that there may be various types of weaving errors or defects D.

Some of said types are shown in the enclosed figures.

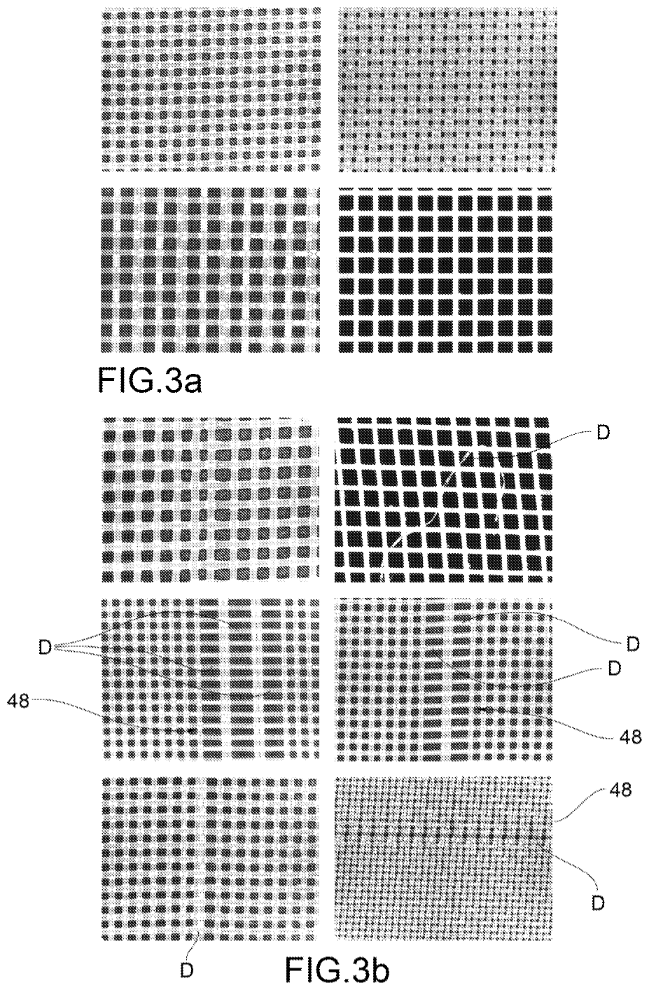

For example, FIG. 3b shows an overview of various kinds of defects D.

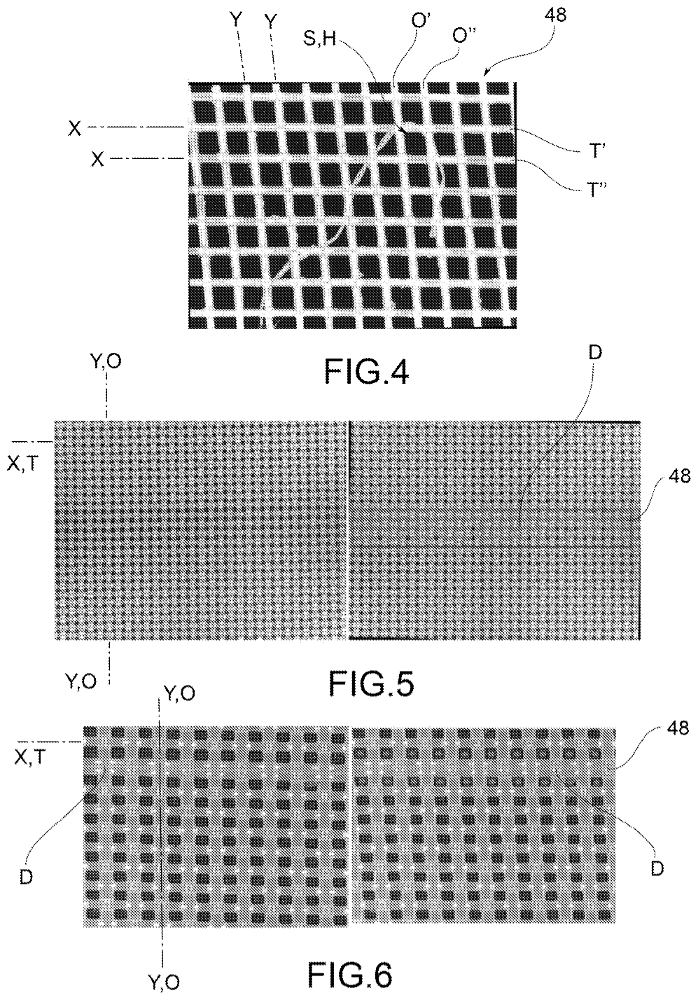

In greater detail, FIG. 4 shows a defect D due to the presence of a thread in the weave; FIG. 5 shows a weft bar defect D while FIG. 6 shows a defect D with a double weft.

The operation of a defect detection device according to the invention will now be described.

Above all, the real-time quality control system for fabrics on the loom using optics calls for the gathering, generation, and processing of fabric images in real time. To do this, the optics must accurately follow the weaving of the fabric by weaving machine 4 that is physically producing fabric 24.

Weaving machine 4 has a relatively slow speed of production of fabric 24; this facilitates the scanning step which uses a load-bearing or support frame structure 12 for supporting video camera 20 which scans fabric 24, and also facilitates the operation of the accessory parts used to move video camera 20.

The viewing system for fabric quality control on the loom is made of a mechanical support with a crossbar 16 on which one or more video cameras 20 are mounted, said video cameras scanning 100% of production as they move along the entire width of the fabric.

In other words, the optics, i.e. video camera 20, are mounted on movement means 40, typically a carriage that can slide crosswise on said crossbar 16, which is as wide as weaving machine 4 that produces fabric 24. In this way the carriage supporting video camera 20 is capable of sliding crosswise and covering the entire width of fabric 24 as it is produced.

By means of one or more electric motors (such as movement means 40) video cameras 20 are moved on crossbar 16 so as to always frame the entire width of fabric 24. As video camera 20 moves, it captures images that are then sent to processing and control unit 44.

Consequently, the video camera is provided with alternating linear transversal movement parallel to said weft direction X-X; at the same time, fabric 24 being formed, driven by weaving machine 4, moves in warp direction Y-Y.

Weaving machine 4 provides information on the production speed of fabric 24 (in picks per minute) to movement means 40 supporting video camera 20. This data transmission take place using the CANBUS protocol, for instance.

Processing and control unit 44 also receives information on the fabric weft (i.e. the diameter and density of inserted wefts per cm of fabric) from weaving machine 4: in this way processing and control unit 44 may calculate how many centimeters of fabric 24 per minute are produced by weaving machine 4 (cm/min), thus giving the speed at which movement means 40 supporting video camera 20 must slide crosswise from one side to the other of support frame 12 to cover the entire width of fabric 24 as it is being made, i.e. in real time.

In this way movement means 40, i.e. the carriage, supporting video camera 20 will always have a crosswise speed allowing video camera 20 to frame the entire width of fabric 24 as it is produced in real time, thus successfully capturing images of fabric 24 as it is being produced, without skipping any portions.

Obviously, video camera 20 has optics with their own field of vision (that is, the size of the area that it is able to frame): said field of vision is a known piece of data of video camera 20, and from it one can estimate the maximum translational speed along weft direction X-X at which movement means 40 (i.e. the carriage), supporting video camera 20, may travel to succeed in totally scanning fabric 24 in real time as it is being made.

If the maximum allowed speed is not enough for a total scan of fabric 24 in real time, more than one video camera 24 will need to be installed meaning a plurality of carriages (such as movement means 40) on crossbar 16 that supports them. Each said movement means 40 will be independent of the others and will have a predetermined area of the fabric to scan, in which it may move along weft direction X-X with an alternating linear motion.

Another known, fixed parameter is the focal length of video camera 20 which determines the distance at which video camera 20 needs to be in order to correctly frame fabric 24 and capture images in focus.

Support frame 12 ensures the rigidity of the system and correct positioning during the entire operation; it also dampens the effect of the vibrations generated during the weaving process.

After the images are sent to processing and control unit 44, they are processed by the algorithm, which decides where there are defects and where there aren't any, in which case the image is discarded. In other words, only images with defects are stored in the database for subsequent inspection.

In addition, fabric portions 48 containing defects are mapped, that is, processing and control unit 44 stores their weft and warp coordinates in relation to the fabric.

The system then creates the defect location map by interfacing with support frame 12, which promptly provides it with the position by giving the x-axis (weft) and y-axis (warp) coordinates based on the point where fabric production starts.

The mapping makes it possible to go look at the piece virtually to understand where the defects are located and to position future cuts with the downstream systems for garment making. With the defect map it is further possible to go and quickly inspect the piece after production without performing further checks. The subsequent processes can be optimized to reduce their time and cost.

In this way, inspection by an operator with an inspection machine after the processes is eliminated.

It must be noted that in this way the processing and control unit is capable of providing the coordinates of the defects, and therefore the coordinates for making the fabric cuts based on its cataloguing and intended purpose.

For example, if the fabric portion is completely free of defects then the section of fabric can be used for a visible portion in its future use, such as the front part of a shirt. If, however, the fabric portion has a defect (properly catalogued) then the fabric cut can be used, for instance, in a less visible portion, such as a shirt cuff and the like.

It must be noted that the algorithm implemented by the processing and control unit, by its very design, does not require any instructions but may work and find defects in the fabric right away, because it performs a geometric calculation directly on the shape/geometry of the fabric by means of the aforementioned theoretical and actual dimensional parameters.

Indeed, by calculating the shape, area, and dimensions of the weave between the weft and warp, the algorithm is able to determine if the image is perfect and therefore whether the fabric is free of defects, or if there are irregularities and therefore defects in the fabric.

A collection of typical defects may be gathered to create a database that can categorize a defect based on requirements.

Upon identifying a defect, the system may just indicate it or it may even stop production based on the category and instructions provided to the weaving machine.

The system makes a map of the defects to identify their location and make it possible to identify defective and good areas of the pieces during the processes following production. In this way subsequent operations can be optimized with an attendant savings in costs and time.

In greater detail, the algorithm implemented by processing and control unit 44 for the quality control of fabric 24 as it is being made is primarily based on a principle of geometric verification of the configuration of fabric 24.

Fabric 24 leaves “holes” between the weft and warp which, due to the way fabric 24 is produced with weaving machine 4, obviously always have the same size (with the weft and warp staying the same). This makes it very regular in terms of geometry and therefore also very easy to see and check.

As seen earlier, video camera 20 captures continuous images of fabric 24 in real time and said images frame an area of fabric the size of the field of vision of video camera 20.

In this portion of fabric 24 there will be a number N of holes or openings H depending on the dimensions of the weft T and warp O threads; the number of openings or holes H also determines the size of these openings or holes H, and therefore the sizing of video camera 20 of the system must also be determined based on the size of holes H to be framed.

These areas of fabric where openings or holes H formed between weft T and warp O, if arranged one next to the other, form the complete image of fabric 24 that is being produced.

Video camera 20 does nothing more than to frame the image and project it onto a sensor (not shown) which captures the image (the sensor is inside the system behind video camera 20). Once the image has been captured, processing and control unit 44 performs operations on the image, converting it to black and white and arranging it so that openings or holes H are perfectly visible.

At this point, the image appears as a series of little black squares corresponding to said holes H. The inspection algorithm does nothing more than analyze each square (or all of them) and calculate for each one the area S and the centroid C (the midpoint of area S).

With this calculation, the algorithm implemented by processing and control unit 44 checks whether the square or hole H corresponds to the dimensions it should have or not, and may also correlate neighboring or adjacent squares H to each other to identify an extensive defect.

If centroid C and area S do not comply with the theoretical calculation based on the dimensions they should have, it means that there is a defect and square H is marked as defective. This entire process takes place in real time during the production of fabric 24.

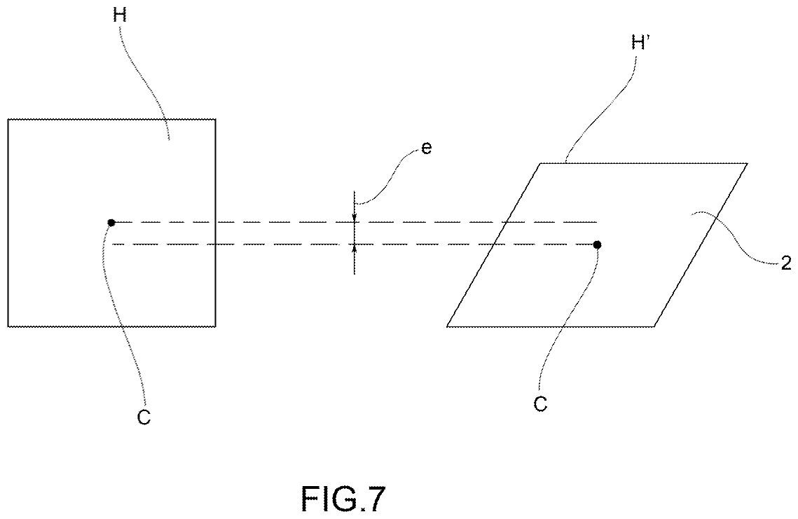

Any deformations in square H or mistaken measurements of its sides are already checked and included in the analysis of the algorithm, because the calculation of centroid C also implicitly includes this type of verification. In other words, a deviation of the position of centroid C from the theoretical position implies a deformation of opening or hole H and therefore of its sides. An example of deviation of centroid C is shown in FIG. 7 where there is a difference of “e” between centroid C of theoretical hole H (on the left) and centroid C′ of actual hole H′ on the right.

As can be seen from the description above, this invention overcomes the drawbacks of the prior art.

Indeed, the present invention provides an economical system for conducting quality control of fabrics on the loom, with real-time identification of defects generated during production using a video camera. The equipment is simple and may be installed on any loom, even ones that clients already have: it is therefore possible to perform a retrofitting operation on existing looms.

The algorithm for viewing and identifying defects is capable of working in a simple and independent way while identifying defects, even in the absence of special databases. The generated images are only stored if they contain defects for future inspection, and the piece is mapped so as to speedily and easily identify defects after the fact.

The advantages are genuinely numerous and tangible compared to known solutions, as they make it possible to:
scan the fabric on the loom as it is being made, that is, in real time, to detect defects therein,
eliminate subsequent checks by an operator on an inspection machine,
eliminate waste due to the production of defective pieces,
reduce total process times,
reduce manual operations, and reduce fabric inspection machine operations,
correct defects on the machine as soon as they are detected,
stop the machine or issue a warning to avoid repeated defects caused by the process,
detect defects in real time,
obtain an independent defect detection algorithm not requiring training (thus reducing the time and cost to set up the system),
not require a database for defect recognition, with the associated problems in terms of implementation cost and time,
easily categorize defects for processing,
map pieces for subsequent evaluation and processes.

Furthermore, the algorithm is also capable of measuring the dimensions of the holes and providing a tool for continuous dimensional evaluation of the quality of the fabric, beyond the actual defect itself.

In a nutshell, the algorithm independently detects defects and does not require a database or training. It does not depend on the type of defect but manages to reveal all defects in a more thorough and versatile way compared to the prior art solutions.

In an effort to meet specific and contingent requirements, a person skilled in the art may make numerous modifications and variants to the devices and methods described above, all of which are included in the scope of the invention as defined by the following claims.

1. A defect identification device for identifying defects in fabrics, comprising:
a support frame fitted with a crossbar supporting at least one video camera for capturing images of a fabric while it is being woven,
movement means for moving the at least one video camera so as to frame the weaving process in real time,
a processing and control unit programmed to:
control the movement means to move the video camera automatically in real time along a transverse weft direction (X-X) so as to follow the weaving steps of the fabric being formed,
acquire in advance the geometry of the fabric to be made and set at least one theoretical dimensional parameter of comparison and a tolerance limit value for said theoretical dimensional parameter,
capture images of the fabric being formed in real time,
process said images so as to acquire the actual dimensional parameter, corresponding to the theoretical dimensional parameter, obtained for the fabric being formed and compare it to the theoretical dimensional parameter,
detect the presence of a weaving error if the difference between the actual dimensional parameter and the theoretical dimensional parameter is greater than the tolerance limit value,
store the coordinates of the corresponding fabric portions that have weaving errors or defects, said coordinates being relative to a weft (T) and a warp (O) of the fabric.

2. A defect identification device for identifying defects in fabrics according to claim 1, wherein said processing and control unit is programmed to store images of the fabric portions having weaving errors or defects.

3. A defect identification device for identifying defects in fabrics according to claim 1, wherein said theoretical dimensional parameter comprises the theoretical density of the weft and/or warp threads.

4. A defect identification device for identifying defects in fabrics according to claim 1, wherein said theoretical dimensional parameter comprises the thickness of the weft and/or warp threads.

5. A defect identification device for identifying defects in fabrics according to claim 1, wherein said theoretical dimensional parameter comprises the area of the holes (H) resulting from the intersection of two consecutive weft threads (T′, T″) and two consecutive warp threads (O′, O″) intersecting each other.

6. A defect identification device for identifying defects in fabrics according to claim 5, wherein said theoretical dimensional parameter comprises the measurement of the sides of said holes (H).

7. A defect identification device for identifying defects in fabrics according to claim 1, wherein the processing and control unit is programmed to catalogue the type of defect (D) based on the number and type of non-compliant theoretical dimensional parameters.

8. A defect identification device for identifying defects in fabrics according to claim 1, wherein the processing and control unit is programmed to catalogue the type of defect (D) by the amount of the difference.

9. A defect identification device for identifying defects in fabrics according to claim 1, wherein the support frame of the defect identification device is mechanically separate from the weaving machine frame.

10. A defect identification device for identifying defects in fabrics according to claim 1, wherein the support frame sits on the floor or is secured to structural parts of the weaving machine and is positioned by means of special spacers at a correct focal distance from the fabric so as to frame perfect images by means of the video camera.

11. A defect identification device for identifying defects in fabrics according to claim 10, wherein damping feet secured to said spacers are provided to attenuate and not transmit vibrations to the support frame of the video camera.

12. A defect identification device for identifying defects in fabrics according to claim 1, wherein said processing and control unit is programmed to determine the correct focal length between the video camera and the fabric to be framed according to the focal length and/or field of vision of the video camera to capture in-focus images of the fabric.

13. A defect identification device for identifying defects in fabrics according to claim 1, wherein said processing and control unit is programmed to set the translational speed of the video camera in the weft direction (X-X) as a function of the fabric production speed and/or the type of fabric weft to be made and/or the field of vision of the video camera.

14. A defect identification device for identifying defects in fabrics according to claim 1, wherein the defect identification device for identifying defects in fabrics comprises at least one screen for displaying at least the fabric portions with defects (D).

15. A method for identifying defects in fabrics comprising steps to:
acquire in advance the geometry of the fabric to be made and set at least one theoretical dimensional parameter of comparison and a tolerance limit value for said theoretical dimensional parameter,
capture images of the fabric being formed in real time using a video camera that follows the fabric being formed in real time b automatically moving along a weft direction (X-X) of the fabric,
process said images so as to acquire said actual dimensional parameter of the fabric being formed and compare it to the theoretical dimensional parameter,
detect the presence of a weaving error if the difference between the actual dimensional parameter and the theoretical dimensional parameter is greater than the tolerance value,
store the coordinates of the corresponding fabric portions having weaving errors or defects (D).

16. A method according to claim 15, comprising a step for storing the images of the fabric portions having weaving errors or defects (D).

17. A method according to claim 15, wherein said theoretical dimensional parameter comprises the theoretical density of the weft (T) and/or warp (O) threads.

18. A method according to claim 15, wherein said theoretical dimensional parameter comprises the thickness of the weft (T) and/or warp (O) threads.

19. A method according to claim 15, wherein said theoretical dimensional parameter comprises the area (S) of the holes (H) resulting from the intersection of two consecutive weft threads (T′, T″) and two consecutive warp threads (O′, O″) intersecting each other.

20. A method according to claim 19, wherein said theoretical dimensional parameter comprises the measurement of the sides of said holes (H).

21. A method according to claim 19, wherein said theoretical dimensional parameter comprises a centroid (C), i.e. a midpoint of area S of said holes (H).

22. A method according to claim 15, comprising a step for cataloging the type of defect (D) as a function of the number and type of non-compliant theoretical dimensional parameters.

23. A method according to claim 15, comprising a step for cataloging the type of defect (D) as a function of the amount of the difference.

24. A method according to claim 15, comprising a step for subdividing the fabric into areas without errors or defects (D) and with errors or defects (D), and wherein a step is provided for cataloging the areas with errors or defects (D) as a function of the number and/or the type of error or defect (D).

25. A method according to claim 15, comprising a step for setting the translational speed of the video camera in the weft direction (X-X) as a function of the fabric production speed and/or the type of fabric weft to be made and/or the field of vision of the video camera.
